(19) United States
(12) Patent Application Publication
(10) Pub. No.: US 2005/0273251 A1
(43) Pub. Date: Dec. 8, 2005

(54) Turn-by-turn navigation system with special routing features

(76) Inventors: Axel Nix, Birmingham, MI (US); Andrew W. Gellatly, Macomb, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 10/850,792

(22) Filed: May 21, 2004

(51) Int. Cl. G01C 21/26

(52) U.S. Cl. 701/201; 340/995.16

(57) ABSTRACT

Methods and apparatus are provided for generating route instructions on a turn-by-turn navigation system in a vehicle. Turn instructions can include a turn icon as well as visual and audio prompts. The turn-by-turn navigation system includes special routing features, such as “Where am I”, “Verification”, “Stop by”, pre-set destinations, and time-restricted road routing. The turn-by-turn navigation system can generally be produced more economically than a typical premium system having a full complement of costly features, such as a color map display. Moreover, the turn-by-turn navigation system can be configured with only those features deemed most useful to a broad-based market segment, in order to further reduce manufacturing costs.

### TECHNICAL FIELD

The present invention generally relates to navigation systems for automobiles, and more particularly relates to a turn-by-turn navigation system integrated with an automobile radio.

### BACKGROUND

Recent trends in automobile technology have included the development of navigation systems incorporated within the driver control cluster. These navigation systems are generally designed to help a driver reach a specific destination without using a physical road map. As such, an automobile navigation system can make the driving experience more convenient and enjoyable.

In addition to providing basic driving directions, some navigation systems also supply resource locations, such as restaurants, hospitals, points of interest, and so forth. However, as new features and capabilities are added to automobile navigation systems, the interaction between driver and navigation system can become relatively complex. Therefore, it is desirable to have a driver-to-navigation system control interface that is both convenient and intuitive, in order to minimize driver distraction.

Another consideration affecting the design of automobile navigation systems is the cost associated with implementing various sophisticated features, such as color map displays, synthesized speech commands, touch screens, and the like. As such, the cost/feature trade-off typically becomes a determining factor regarding the degree of complexity designed into a navigation system for the consumer market. Furthermore, the relatively high cost of current “premium” navigation systems, which typically include a profusion of high-tech features, generally limits their marketability to the luxury, or near-luxury, car market.

Accordingly, it is desirable to provide a relatively low cost automobile navigation system that provides route guidance information to a typical consumer/driver. In addition, it is desirable that the low cost automobile navigation system be incorporated into the automobile audio system for convenient and intuitive operation. Furthermore, other desirable features and characteristics of the present invention will become apparent from the subsequent detailed description and the appended claims, taken in conjunction with the accompanying drawings and the foregoing technical field and background.

### BRIEF SUMMARY

According to various exemplary embodiments, devices and methods are provided for presenting route instructions on an automobile navigation system display. One exemplary vehicle navigation system includes a control unit with a visual display that is typically integrated into the audio system of the vehicle. The audio system can include a radio configured to receive various types of reception, such as AM, FM, SDARS, and RDS, among others. A processor is typically electrically coupled to the control unit, and to a database and a vehicle location apparatus, such as a GPS receiver. The exemplary processor is configured to receive vehicle position data from the vehicle location apparatus, to retrieve destination information from the database, to calculate a turn-by-turn route to the destination, and to generate instructions and graphics such as a turn icon image on the visual display.

The database typically contains road-network/address information, and may also contain additional data, such as Point of Interest (POI) information. The exemplary navigation system generally includes voice prompts that are synchronized with the visual instructions and graphics, such as a turn icon, to help the driver navigate accurately, and with minimum visual distraction. The exemplary navigation system typically utilizes turn-by-turn instructions in place of a color map display, and provides those features generally considered to be most useful for a shopping/commuting type of driver. As such, the exemplary system represents an effective and economical alternative to a relatively high cost premium navigation system.

The exemplary turn-by-turn navigation system is further configured with special routing features, including “Where am I” location data, a “Sanity Check” confirmation of the selected destination, “Stop by” routing for intermediate selected destinations, programmable radio pre-set controls for both navigation destinations and radio stations, and routing for time-restricted roads when legally open, based on the estimated time of arrival at the time-restricted roads.

### BRIEF DESCRIPTION OF THE DRAWINGS

The present invention will hereinafter be described in conjunction with the following drawing figures, wherein like numerals denote like elements, and

FIG. 1 is a block diagram of an exemplary automobile navigation system;

FIG. 2 is an illustration of an exemplary control panel for an automobile navigation system;

FIG. 3 is an illustration of an exemplary control panel display in the “Radio Only” mode;

FIG. 4 is an illustration of an exemplary “Where am I” display in the “Navigation Only” mode;

FIG. 5 is an illustration of an exemplary control panel display in the “Split Radio/Nav” mode;

FIG. 6 is a flow diagram of an exemplary control sequence for an automobile navigation system;

FIG. 7 is an illustration of an exemplary “Sanity Check” display;

FIG. 8 is an illustration of exemplary POI and “stop by” lists;

FIGS. 9 and 10 are illustrations of a pre-set destination capability;

FIG. 11 is an illustration of an exemplary “Turn List” display;

FIG. 12 is an illustration of an exemplary turn icon display in a “Navigation Only” mode;

FIG. 13 is an illustration of an exemplary turn icon display in a split “Nav/XM” mode;

FIG. 14 is an illustration of an exemplary turn icon display in a split “Nav/FM-RDS” mode;

FIG. 15 is an illustration of an exemplary turn icon display in a split “Nav/FM” mode; and

FIG. 16 is an illustration of an exemplary turn icon display in a “Navigation Only” mode.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present invention pertain to the area of automobile navigation systems. The exemplary embodiments disclosed herein are particularly configured for the type of user/driver that represents a broad segment of the consumer market. That is, the exemplary navigation system embodiments are especially configured for ease of use, flexibility, and minimal driver distraction. Moreover, the navigation system controls are integrated into the vehicle audio system for added convenience and intuitive operation. The exemplary embodiments provide a wide range of audio and navigation capabilities, while at the same time eliminating certain types of high cost features (e.g., a color map display) having relatively low perceived utility to certain users. As such, the exemplary embodiments represent effective, lower cost alternatives to the premium types of automobile navigation systems.

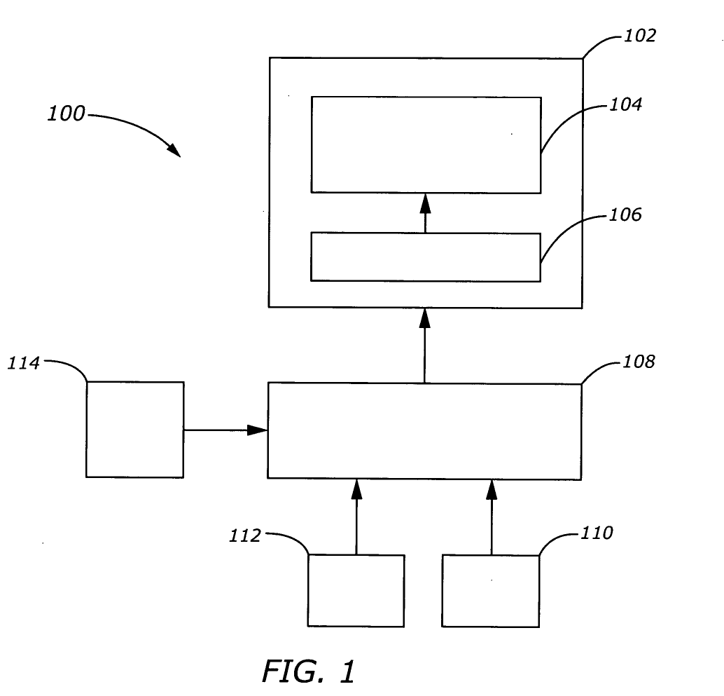

According to an exemplary embodiment of an automobile navigation system 100, as shown in the simplified block diagram of FIG. 1, a control panel 102 provides the interface between the driver and system 100. Control panel 102 typically includes a visual display 104 and a set of manual controls 106, such as buttons, knobs, and the like. A processor 108 manages the flow of data between control panel 102 and the various input devices, including a Global Positioning Satellite (GPS) receiver 110, a radio 112, a database 114 and/or the like.

Processor 108 may be any type of microprocessor, micro-controller, or other computing device capable of executing instructions in any computing language. GPS receiver 110 provides vehicle positioning information to processor 108, typically via an external GPS antenna (not shown), or any other suitable device. Radio 112 is generally connected to an external AM/FM antenna (not shown), for receiving AM and FM broadcast transmissions, and can also be configured to receive other types of signals, such as satellite digital audio radio service (SDARS) and RDS (Radio Data System) signals. Database 114 is typically configured to provide map data, such as road-network/address data for the U.S. and Canada, to processor 108. In addition, database 114 can be further configured to provide other types of data, such as Point Of Interest (POI) data. Database 114 can be implemented by a form of disk media, such as CD, DVD, and the like, or can be implemented by any other suitable type of media, such as flash memory cards or the like. Database 114 may also be configured to provide audio playback capabilities, including CD, DVD, MP3, WMA, and so forth.

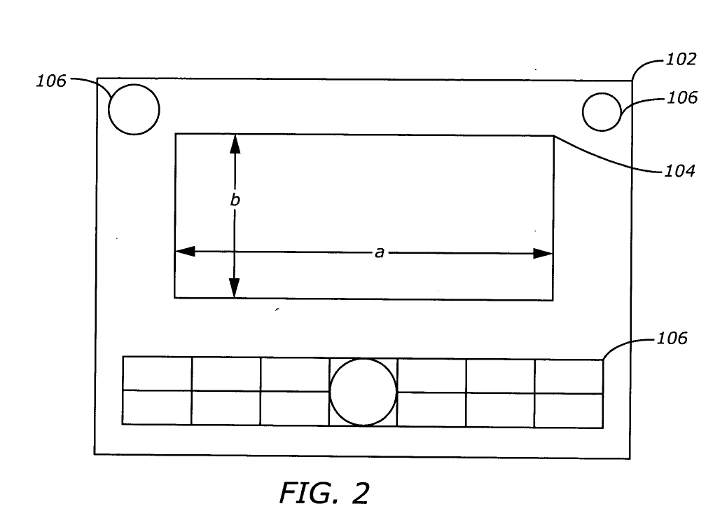

One exemplary physical embodiment of control panel 102 is illustrated in FIG. 2. Control panel 102 can be mounted in any suitable location that allows the driver to conveniently read the data on display 104 and to access controls 106. Display 104 may be sized to be capable of displaying at least 5 lines of 24 characters each, with a minimum character height of approximately 5 mm, although other embodiments may have any dimensions and display resolution. These parameters generally result in a display 104 having dimensions of approximately 125 mm minimum width (a) and approximately 47 mm minimum height (b). In general, LCD technology is used to produce the display characters, although any other suitable display technique (e.g., plasma or the like) may be used. Controls 106 are suitably configured to provide a combination of buttons and knob(s) that enable the driver to conveniently and intuitively access both the radio and navigation features, as will be described in further detail below.

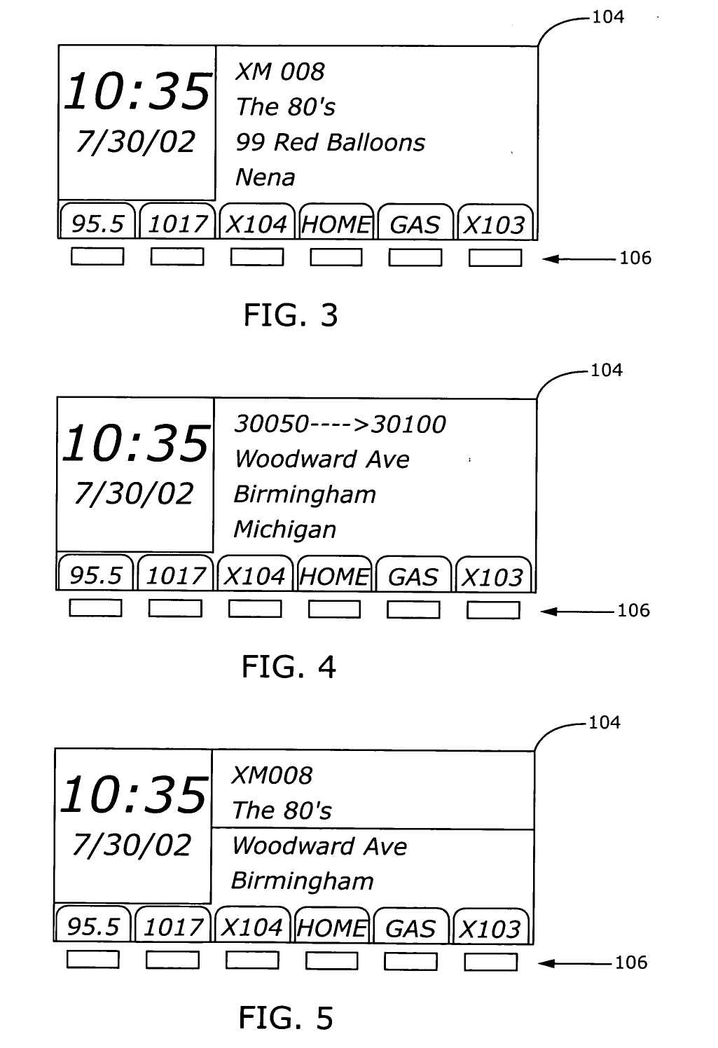

According to one exemplary embodiment, control panel 102 can be configured to operate in three distinct display modes, which can be toggled by pressing an appropriate button 106 or other control on display 102. In the exemplary embodiment, the three display modes are characterized as “Radio Only” mode, “Navigation Only” mode, and “Split Radio/Nav” mode. Exemplary embodiments of the three display modes are illustrated in FIGS. 3, 4 and 5.

The “Radio Only” display mode is typically designated as the default mode, where the driver has not requested navigation information. As shown in FIG. 3, the “Radio Only” mode can be configured to display time and date information from processor 108, as well as radio 112 reception data, on display 104. In the FIG. 3 example, radio 112 is shown as receiving satellite (e.g., XM) data. In similar fashion, AM and FM data would typically be displayed if those modes were selected by the driver. Display 104 can also be configured to display additional selection choices (e.g., 95.5, 1017, X104, etc.) using associated controls 106, as illustrated in FIG. 3.

An exemplary “Navigation Only” display mode is shown in FIG. 4. In this embodiment, the vehicle location is displayed in addition to time and date information. Vehicle location is typically displayed as a default function in a Navigation mode, prior to a driver request for destination routing information. Vehicle location may also be selected by the driver with the activation of a “where am I” or similar button. This exemplary “where am I” feature typically provides vehicle position information as shown in FIG. 4, including address range, street name, city and state. Moreover, the exemplary address range display can include a direction indicator (e.g., an arrow) to show which way the vehicle is moving within the address range.

An exemplary “Split Radio/Nav” display mode is illustrated in FIG. 5. In this example, the audio data (XM) and navigation data (e.g., vehicle location) are displayed on a split screen portion of display 104, in addition to the time and date display portion. Other multi-function display mode embodiments could be used as well, such as Picture-within-Picture (PIP) and other types of graphical combinations.

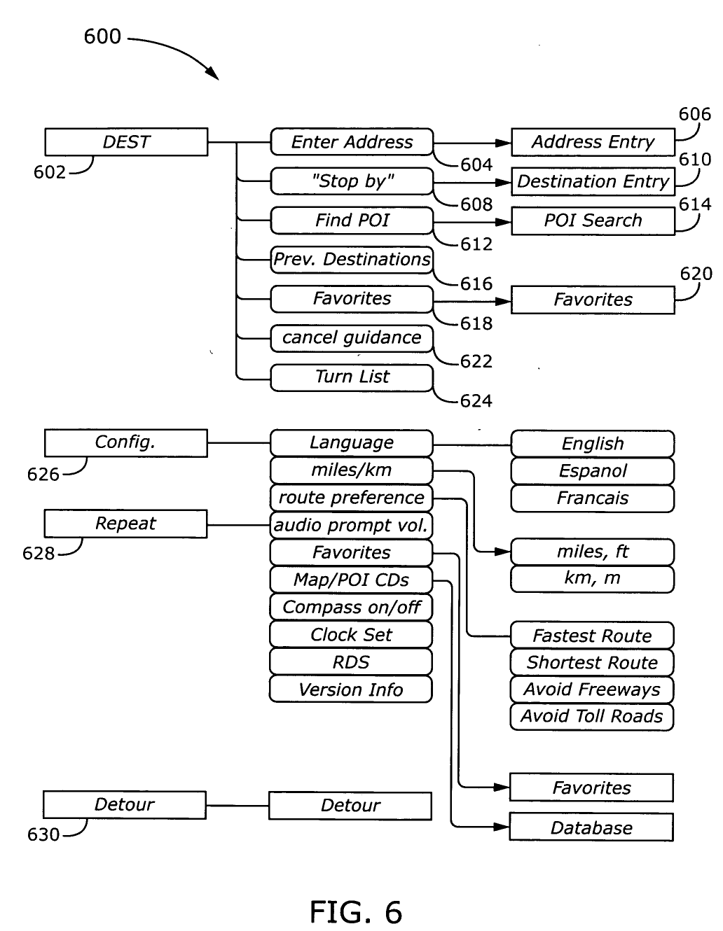

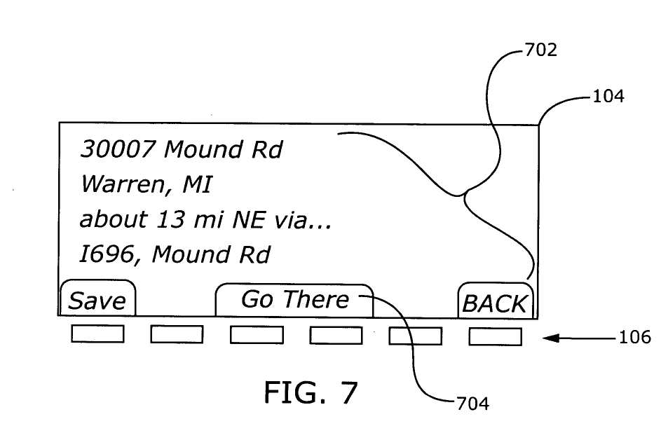

In accordance with one exemplary embodiment of an automobile navigation system, a top-level menu of selections 600 available in system 100 (FIG. 1) is illustrated in FIG. 6. For example, a driver can initiate a route guidance mode by activating “Destination” menu 602 and entering an address 604, 606 via controls 106. Once the address has been entered, the system typically calculates a route from the present vehicle position to the destination address. The exemplary navigation system can also confirm that the entered address is the desired destination by displaying a “verification” screen 702, such as the screen shown in FIG. 7, which would typically show the general direction and approximate straight-line distance to the requested destination. If the verification information is satisfactory, the driver can then activate the route guidance mode by pressing an appropriate soft key, such as a “Go there” key 704. The driver can typically exit the route guidance mode by depressing a soft key, such as “cancel guidance” 622.

The driver can be given additional options, as indicated in FIG. 6, such as making an intermediate “stop by” 608, 610 (if route guidance is active), locating a POI 612, going to a previous destination 616, or to a “Favorite” destination 618, 620. For example, if a driver has selected a final destination (route guidance active), but also wants to stop by an intermediate destination on the way (e.g., a McDonalds), the exemplary navigation system can activate a “stop by” preference algorithm. This exemplary preference algorithm considers the vehicle position and the final destination in order to determine a routing that can enable the driver to stop at the desired intermediate destination while “on the way” to the final destination.

On the other hand, if the driver has not selected a final destination (route guidance not active), but requests a POI 612, 614 (e.g., a restaurant), the exemplary navigation system can generate a list of alternate restaurant locations sorted by increasing distance from the vehicle position, based on information stored in a POI portion of database 114 (FIG. 1). That is, the alternate restaurant location list is typically sorted with respect to increasingly distant concentric circles around the present vehicle position, as described below.

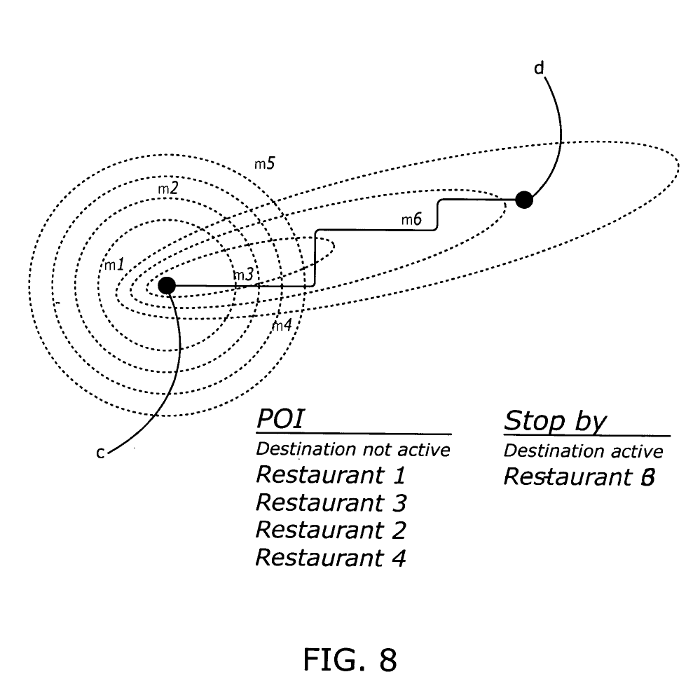

The two preceding examples of “stop by” and “POI” list generation are illustrated in FIG. 8, where the “stop by” route example starts at point “c” (vehicle position) and stops by restaurants 3 and 6, which are on the way to point “d” (final destination). The POI list example is based on increasing distances in all directions from a fixed vehicle position point “c”, since there is no selected final destination in this example.

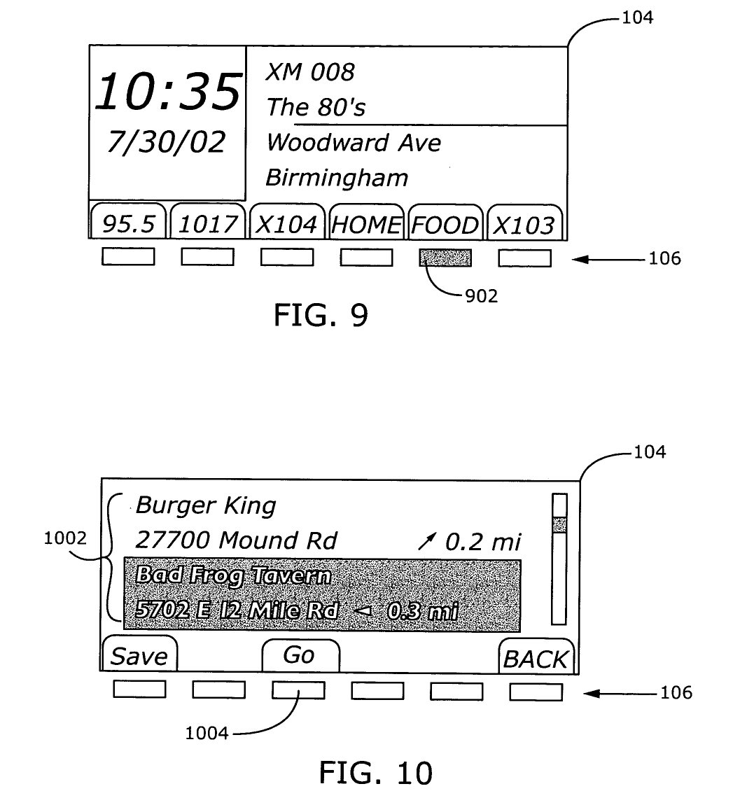

Another option available in the exemplary navigation system is the ability to preset destinations via the “Favorites” selection process 618, 620, as indicated in the flow diagram of FIG. 6. In this exemplary embodiment, a favorite address or POI can be assigned a name by the driver, and the favorite name can then be saved to a radio pre-set button. As such, the radio pre-set buttons can be used for Navigation destinations as well as for radio stations, allowing easy and intuitive access for the driver. One example of this pre-set destination feature is illustrated in FIGS. 9 and 10. In FIG. 9, the exemplary highlighted pre-set button 902 is designated “FOOD” on display 104. When pre-set button 902 is activated by a driver, a pre-set list of favorite food destinations 1002 can be generated by the exemplary system and shown on display 104, as illustrated in FIG. 10. The driver can then select a desired food destination (e.g., “Bad Frog Tavern”), and then activate the route guidance mode by pressing an appropriate soft key 1004 (e.g., “Go”). This exemplary pre-set destination feature can enable a driver to select a favorite destination quickly and conveniently with minimal distraction from his/her driving responsibilities.

Another exemplary feature available in the activated route guidance mode is a “Turn List”, which the driver can access by pressing an appropriate soft key 624 in the Destination 602 menu (FIG. 6). The Turn List typically displays a summary of distance, direction and turn-into street names of upcoming turns. As noted previously, the exemplary embodiments disclosed herein do not typically include a color map display, in order to reduce the cost and complexity of the system. Instead, turn-by-turn information is generally supplied to the driver in both visual and audio forms, as will be described below. As such, the exemplary embodiments disclosed herein can be categorized as “Turn-By-Turn” navigation systems.

Additional exemplary selective modes may also be made available to the driver, as are illustrated in FIG. 6, such as “Configure” 626, “Repeat” 628, and “Detour” 630, among others. The various optional features extending from these additional exemplary modes are generally accessible to the driver through the activation of appropriate sequences of soft keys, as indicated in the exemplary respective flow diagrams of FIG. 6.

According to various further embodiments, the routing choices can include time-restricted roads and turns. An exemplary navigation system can provide routing instructions that include the use of time-restricted roads if the roads are legally open at the expected time of use. In the exemplary system, the decision for whether or not to use time-restricted roads and turns is generally based on the estimated time of arrival (ETA) at the road or turn in question. An initial ETA at each road/turn can be calculated by the exemplary system on the basis of average driver habits and an immediate departure. During route guidance, the ETA at each road/turn can be continually updated by the exemplary system. If an updated ETA indicates that a road/turn can no longer be used legally, the exemplary system can automatically calculate an alternate route based on information from a Map portion of database 114 (FIG. 1), and can activate the alternate route. If an updated ETA indicates that a more favorable route is available than previously assumed, the exemplary system can automatically update the route. In this latter case, a warning message can be generated by the exemplary system to allow the user to decide whether or not to activate the new route.

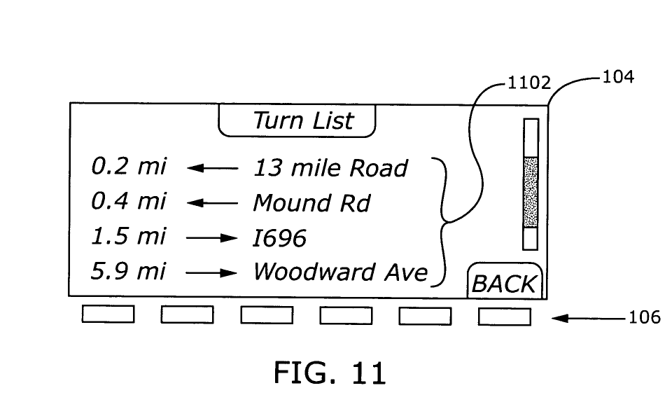

In an exemplary embodiment of a “Turn-By-Turn” navigation system, one visual form of turn-by-turn information is typically the Turn List, as previously described. An exemplary Turn List 1102 is generally shown in tabular form on display 104, as illustrated in FIG. 11. In this display example, the distance, direction, and turn-into street names of upcoming turns are listed in simple, easy-to-read format. For example, the first line in the displayed listing indicates an upcoming left turn, 0.2 miles ahead, onto 13 mile Road.

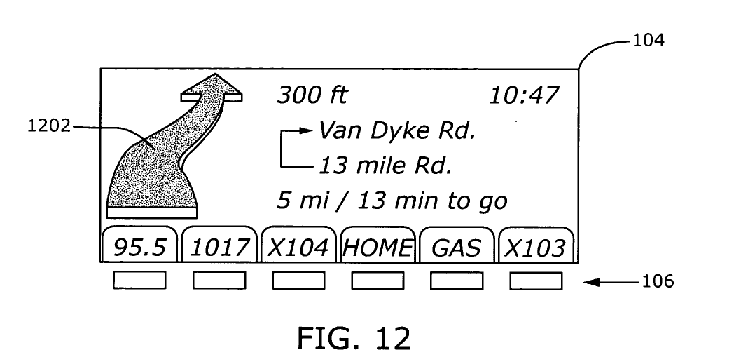

Another exemplary visual form of turn-by-turn information is shown in FIG. 12, where a turn icon 1202 is presented graphically on display 104 to indicate an upcoming turn. In this example, route data is shown on display 104 as would be typically presented in the “Navigation Only” mode.

In addition to the types of visual displays described herein, various embodiments of exemplary Turn-By-Turn navigation systems generally incorporate audible voice prompts. Voice prompts are typically synchronized with visual turn instructions in order to help the driver navigate to the desired destination with minimal visual distraction. For example, voice prompts can announce an upcoming turn in three steps, as follows:
1) A first voice prompt may suggest: “Prepare to turn”.
2) A second voice prompt may announce detailed turn instructions, such as: “Turn right onto I 75 north in one half mile”.
3) A final prompt may be played immediately before the turn must be made: “Turn right now”.

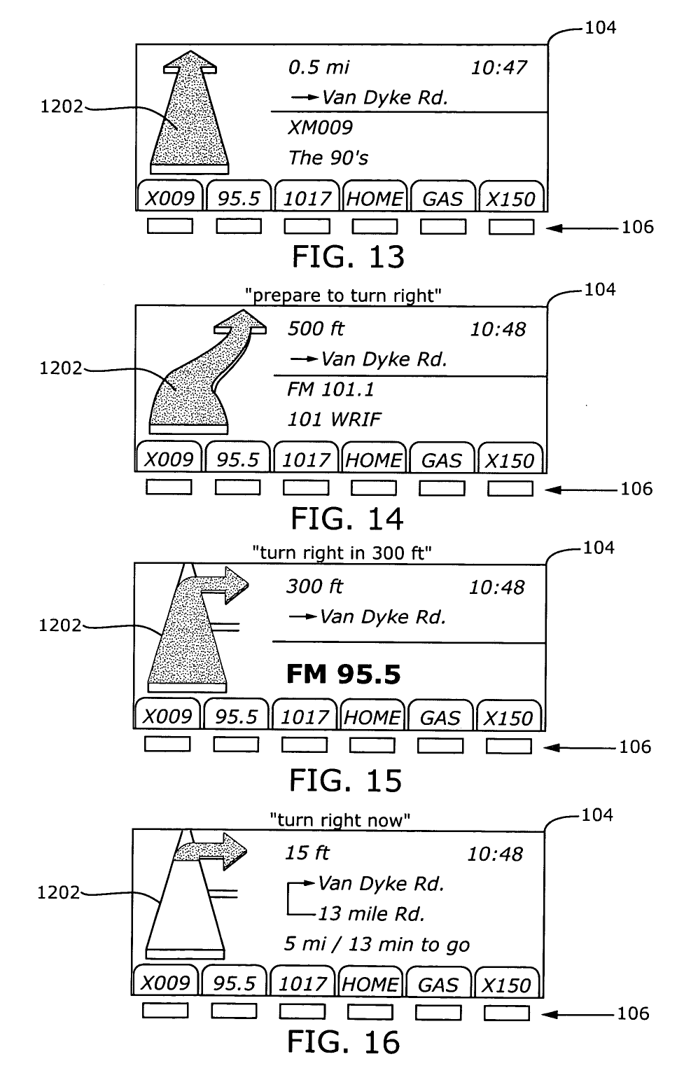

To further aid the driver in processing turn information, the previously described turn icon (1202 in FIG. 12) can be graphically enhanced in various ways. For example, when an upcoming turn is still a considerable distance away, such as 0.5 mile or more, turn icon 1202 can be displayed as an arrow pointing straight ahead, as illustrated in FIG. 13. Also, the exemplary displayed data in FIG. 13 is representative of the Split Radio/Nav mode, where XM is the selected audio mode.

When the vehicle reaches a distance of approximately 500 feet from the upcoming turn, turn icon 1202 can be displayed as a bent arrow, as illustrated in FIG. 14. Concurrently, a voice prompt can announce: “prepare to turn right”. In this example, the displayed data is representative of the Split Radio/Nav mode, where FM-RDS is the selected audio mode.

When the vehicle begins to approach the upcoming turn, e.g., at about 300 feet, turn icon 1202 can be displayed as a right-angle arrow, as illustrated in FIG. 15. Concurrently, a voice prompt can announce: “turn right in 300 feet”. In this example, the displayed data is representative of the Split Radio/Nav mode, where FM is the selected audio mode.

When the vehicle is close to the upcoming turn, e.g., at a distance of about 15 feet, turn icon 1202 can revert to a right-angle arrow, as depicted in FIG. 16. Concurrently, a voice prompt can announce: “turn right now”. In this example, the displayed data is representative of the Navigation Only mode, with no audio selection.

Accordingly, the shortcomings of the prior art have been overcome by providing an improved automobile navigation system based on a turn-by-turn route guidance concept. Exemplary embodiments of a versatile, yet economical, navigation system are disclosed, with a graphic turn icon and associated visual and voice prompt instructions used in lieu of a costly color map display. Various enhanced routing features can also be incorporated into the exemplary navigation system embodiments, such as “Where am I” access, automatic “verification”, “stop by” routing, pre-set destination buttons, and time-restricted road/ETA routing, among others. The exemplary embodiments described herein can provide enhanced routing capabilities in a relatively low cost automobile navigation system, with convenient and intuitive controls integrated into the radio system to minimize driver distraction.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A turn-by-turn navigation system in a vehicle, comprising:
a control unit having a visual display and destination selection controls;
a processor electrically coupled to the control unit and configured to receive destination selections from the control unit;
a radio having programmable pre-set controls electrically coupled to the processor;
a database comprising road-network/address information and configured to input database information to the processor; and
a vehicle location apparatus configured to input vehicle location data to the processor;
wherein the processor is configured to generate route information between the vehicle location and a selected destination based upon received vehicle location data from the vehicle location apparatus, received destination selection information from the control unit and upon received road-network/address data from the database, and wherein the processor is further configured to generate visual displays of the route information.

2. The turn-by-turn navigation system of claim 1 wherein navigation destinations and radio stations are programmed into the radio pre-set controls.

3. The turn-by-turn navigation system of claim 1 wherein the processor is further configured to display vehicle location data comprising street name, city and state names, address range, and the direction the vehicle is moving within the address range.

4. The turn-by-turn navigation system of claim 1 wherein the processor is further configured to display route verification information comprising the selected destination address, the approximate distance and direction from the vehicle location to the selected destination, and a basic route summary.

5. The turn-by-turn navigation system of claim 1 wherein the processor is further configured to sort the selected “Stop by” destinations in accordance with increasingly distant concentric circles centered on the vehicle location if no final destination has been designated.

6. The turn-by-turn navigation system of claim 1 wherein the processor is further configured to sort the selected intermediate “Stop by” destinations in accordance with “on the way” routing convenience between the vehicle location and a final destination if the final destination has been designated.

7. The turn-by-turn navigation system of claim 1 wherein the processor is further configured to estimate the time of arrival at a time-restricted road based on average driver habits.

8. The turn-by-turn navigation system of claim 1 wherein the processor is further configured to estimate the time of arrival at a time-restricted road based on immediate departure.

9. The turn-by-turn navigation system of claim 1 wherein the processor is further configured to generate an alternate route to replace the time-restricted road route if the time-restricted road is not legally open at the estimated time of arrival.

10. A method of providing location information to a driver on a visual display associated with a turn-by-turn navigation system in a vehicle, comprising the steps of:
receiving vehicle location information from an external source;
retrieving road-network/address data from a database;
generating the location information based on the received vehicle location information and the retrieved road-network/address data; and
displaying the location information on the visual display.

11. The method of claim 10 wherein the displayed location information comprises street name, city and state names, address range, and the direction the vehicle is moving within the address range.

12. The method of claim 11 wherein the direction of vehicle movement is represented by an arrow associated with the address range.

13. A turn-by-turn navigation system for a vehicle, comprising:
a control unit having a visual display and destination selection controls;
a processor electrically coupled to the control unit and configured to receive destination selections from the control unit;
a radio electrically coupled to the processor;
a database comprising road-network/address information and configured to input database information to the processor; and
a vehicle location apparatus configured to input vehicle location data to the processor;
wherein the processor is configured to generate route information between the vehicle location and a selected destination, based on received vehicle location data from the vehicle location apparatus, and on received road-network/address data from the database, and to generate location information on the visual display, wherein the location information comprises street name, city and state names, address range, and the direction the vehicle is moving within the address range.

14. The navigation system of claim 13 wherein the navigation system comprises a plurality of operating modes.

15. The navigation system of claim 14 wherein the location information is displayed in any of the plurality of operating modes.

16. The navigation system of claim 15 wherein the plurality of display modes comprises a “Radio Only” mode, a “Navigation Only” mode, and a “Split Radio/Nav” mode.

17. A method for enabling a driver to confirm the validity of a selected destination on a turn-by-turn navigation system in a vehicle, comprising the steps of:
receiving vehicle position information from an external source;
receiving selected destination information from a database;
calculating an approximate distance and direction from the vehicle position to the selected destination; and
displaying the calculated approximate distance and direction information on a visual display associated with the turn-by-turn navigation system to enable the driver to confirm the selected destination prior to activating turn-by-turn route guidance.

18. The method of claim 17 wherein the displayed distance and direction information comprises a selected destination address, an approximate distance and direction from the vehicle position to the selected destination, and a basic route summary.

19. A turn-by-turn navigation system for a vehicle having a driver, the system comprising:
a control unit having a visual display and destination selection controls;
a processor electrically coupled to the control unit and configured to receive destination selections from the control unit;
a database comprising road-network/address information and configured to input database information to the processor; and
a vehicle location apparatus configured to input vehicle location data to the processor;
wherein the processor is configured to generate route information between the vehicle location and a selected destination, based on received vehicle location data from the vehicle location apparatus, on received selected destination information from the control unit, and on received road-network/address data from the database, and to generate route verification information from the vehicle location to the selected destination on the visual display, to thereby allow the driver to confirm the validity of the selected destination prior to activating a route guidance mode on the turn-by-turn navigation system.

20. The turn-by-turn navigation system of claim 19 wherein the displayed route verification information comprises the selected destination address, the approximate distance and direction from the vehicle location to the selected destination, and a basic route summary.

21. A method of listing “Stop by” destination locations on a visual display of a turn-by turn navigation system for a vehicle, comprising the steps of:
receiving vehicle position information from an external source;
retrieving selected “Stop by” destination location information from a database;
calculating approximate distances and directions from the vehicle position to the selected “Stop by” destination locations; and
listing the selected “Stop by” destinations on the visual display, wherein the selected “Stop by” destinations are sorted by increasing distance from the vehicle position if no final destination has been designated, and wherein the selected “Stop by” destinations are sorted by routing convenience if a final destination has been designated.

22. The method of claim 21 wherein the selected “Stop by” destinations are sorted by increasingly distant concentric circles centered on the vehicle position if no final destination has been designated.

23. The method of claim 21 wherein the selected “Stop by” destinations are sorted by “on the way” routing convenience between the vehicle position and a final destination if the final destination has been designated.

24. A turn-by-turn navigation system for a vehicle having a “Stop by” feature for selected destinations, comprising:
a control unit having a visual display and destination selection controls;
a processor electrically coupled to the control unit and configured to receive destination selections from the control unit;
a database comprising road-network/address information and configured to input database information to the processor; and
a vehicle location apparatus configured to input vehicle location data to the processor;
wherein the processor is configured to generate route information between the vehicle location and a selected destination, based on received vehicle location data from the vehicle location apparatus, on received “Stop by” destination selections from the control unit, and on received road-network/address data from the database, and to generate “Stop by” routing lists on the visual display from the vehicle location to the selected “Stop by” destinations, wherein the selected “Stop by” destinations are sorted by increasing distance from the vehicle location if no final destination has been designated, and wherein the selected “Stop by” destinations are sorted by routing convenience if a final destination has been designated.

25. The turn-by-turn navigation system of claim 24 wherein the selected “Stop by” destinations are sorted by increasingly distant concentric circles centered on the vehicle location if no final destination has been designated.

26. The turn-by-turn navigation system of claim 24 wherein the selected “Stop by” destinations are sorted by “on the way” routing convenience between the vehicle location and a final destination if the final destination has been designated.

27. The turn-by-turn navigation system of claim 24 wherein the selected “Stop by” destinations comprise “Point of Interest” (POI) destinations.

28. The turn-by-turn navigation system of claim 24 wherein the selected “Stop by” destinations comprise “Favorite” destinations.

29. A method of selecting pre-set destinations on a turn-by-turn navigation system for a vehicle, the navigation system having a database and an integrated radio, comprising the steps of:
selecting a destination within the database;
programming the selected destination into a pre-set control of the integrated radio;
activating the programmed pre-set control, wherein the turn-by-turn navigation system generates a route from the vehicle position to the selected destination.

30. The method of claim 29 wherein a destination category is programmed into the pre-set control of the integrated radio.

31. The method of claim 30 wherein the destination category comprises at least one destination.

32. The method of claim 28 wherein the pre-set control of the integrated radio can be programmed for a radio station selection.

33. A turn-by-turn navigation system for a vehicle, comprising:
a control unit having a visual display and destination selection controls;
a processor electrically coupled to the control unit and configured to receive destination selections from the control unit;
a radio having programmable pre-set controls electrically coupled to the processor;
a database comprising road-network/address information and configured to input database information to the processor; and
a vehicle location apparatus configured to input vehicle location data to the processor;
wherein the processor is configured to generate route information between the vehicle location and a selected destination, based on received vehicle location data from the vehicle location apparatus, on a received pre-programmed destination selection from the radio pre-set controls, and on received road-network/address data from the database.

34. The turn-by-turn navigation system of claim 33 wherein the pre-set control of the radio is further programmed for selecting a radio station.

35. The turn-by-turn navigation system of claim 34 wherein the radio comprises an AM mode.

36. The turn-by-turn navigation system of claim 34, wherein the radio comprises an FM mode.

37. The turn-by-turn navigation system of claim 34, wherein the radio comprises an SDARS mode.

38. The turn-by-turn navigation system of claim 34, wherein the radio comprises a Radio Data System mode.

39. The turn-by-turn navigation system of claim 33 wherein the pre-set control of the radio is programmed for a destination category.

40. The turn-by-turn navigation system of claim 39 wherein the destination category comprises at least one destination.

41. The turn-by-turn navigation system of claim 39 wherein the destination category comprises “Point of Interest” (POI) destinations.

42. The turn-by-turn navigation system of claim 39 wherein the destination category comprises “Favorite” destinations.

43. A method of calculating a route having time-restricted roads by a turn-by-turn navigation system in a vehicle, comprising the steps of:
estimating a time of arrival at a time-restricted road from a present vehicle position;
determining whether the time-restricted road is legally open at the estimated time of arrival, wherein the time-restricted road is included in the route if it is legally open at the estimated time of arrival, and wherein the time-restricted road is replaced with an alternate route if the time-restricted road is not legally open at the estimated time of arrival.

44. The method of claim 43 wherein the estimation of the time of arrival is based on average driver habits.

45. The method of claim 43 wherein the estimation of the time of arrival is based on immediate departure.

46. A turn-by-turn navigation system for a vehicle, the system comprising:
a control unit having a visual display and destination selection controls;
a processor electrically coupled to the control unit and configured to receive destination selections from the control unit;
a database comprising road-network/address information and configured to input database information to the processor; and
a vehicle location apparatus configured to input vehicle location data to the processor;
wherein the processor is configured to generate route information between the vehicle location and a selected destination, based on received vehicle location data from the vehicle location apparatus, on a received destination selection from the control unit, and on received road-network/address data from the database, and wherein the processor estimates a time of arrival at a time-restricted road and includes the time-restricted road in the generated route information if the time-restricted road is legally open at the estimated time of arrival, and wherein the processor generates an alternate route to replace the time-restricted road if the time-restricted road is not legally open at the estimated time of arrival.

47. The turn-by-turn navigation system of claim 45 wherein the estimation of the time of arrival at a time-restricted road is based on average driver habits.

48. The turn-by-turn navigation system of claim 45 wherein the estimation of the time of arrival at a time-restricted road is based on immediate departure.
